(19) United States
(12) Patent Application Publication
(10) Pub. No.: US 2024/0328475 A1
(43) Pub. Date: Oct. 3, 2024

(54) EARLY WARNING METHOD, DEVICE, APPARATUS, AND STORAGE MEDIUM FOR HOT SPOTS OF BRAKE DISC

(71) Applicant: Shandong University of Aeronautics, Binzhou (CN)

(72) Inventors: Weitao Sun, Binzhou (CN); Bin Wang, Binzhou (CN); Yuqian Wang, Binzhou (CN)

(21) Appl. No.: 18/733,878

(22) Filed: Jun. 5, 2024

Related U.S. Application Data
(63) Continuation of application No. PCT/CN2022/073964, filed on Jan. 26, 2022.

(51) Int. Cl. F16D 66/00

(52) U.S. Cl. CPC F16D 66/00; F16D 2066/001; F16D 2066/006

(57) ABSTRACT

An early warning method for hot spots of a brake disc includes: acquiring a mixed vibration signal generated when the brake disc is braked; separating the mixed vibration signal to obtain multiple separated vibration signals; and screening the multiple separated vibration signals to obtain hot spot determination signals. The hot spot determination signals are configured to determine formation of the hot spots on the brake disc. By separating the mixed vibration signal generated when the brake disc is braked, the multiple separated vibration signals can be obtained. Each of the multiple separated vibration signals is screened to obtain the hot spot determination signal that reflect whether the hot spots are formed on the brake disc, and the hot spot early warning result is reliable. The early warning method can effectively improve the accuracy of hot spot early warning for brake discs.

### TECHNICAL FIELD

The present disclosure relates to the field of brake disc warning, in particular to an early warning method, an early warning device, an early warning apparatus, and a storage medium for hot spots development on the tribology interface of a brake disc.

### BACKGROUND

Brake disc is a kind of metal disc fitting. A working principle of the brake disc is to cooperate with a brake pad to generate friction, and the energy of running of a motor vehicle can be converted into heat through the friction and the heat is released to the outside, thereby achieving purposes of deceleration and braking. During a braking process, when hot spots form on a surface of the brake disc, the hot spots lead to a temperature gradient of 100 Celsius degrees (° C.) to 700° C. in circumferential and radial directions of the brake disc. The inhomogeneous distribution of temperature field will cause great thermal stress, which will cause thermal deformation on the surface of the brake disc. This thermal deformation will lead to unstable contact between the brake pad and the brake disc, thereby affecting the braking performance of motor vehicles.

There are usually two methods used to determine whether there are hot spots forming on the surface of the brake disc. The first method is thermal infrared imaging temperature measurement, which is the most commonly used technical means. However, accuracy of the first method is deeply affected by emissivity of the brake disc, and other unstable factors such as temperature fluctuations and rotation of the brake disc combine with the emissivity of the brake disc result in significant errors in measurement data. The infrared imaging temperature measurement tends to be static measurement, and hot spot early warning based on the infrared imaging temperature measurement is not accurate. The second method is finite element theory calculation. By using finite element analysis software such as Ansys® and Abaqus® to simulate a braking process based on thermal mechanical coupling, thereby calculating a critical speed of brake disc for hot spot formation. By comparing the critical value with an actual speed of the vehicle, the formation of hot spots can be determined/recognized/judged. When the second method is applied, the formation of hot spots can be avoided by controlling the vehicle speed reasonably. However, the reliability of this method heavily depends on the accuracy of model construction, boundary condition settings, etc., and there are inevitably idealized assumptions in theoretical calculations, leading to a deviation between the calculation result and an actual result. In the related art, there is a problem of large errors in the hot spot early warning of the brake disc.

### SUMMARY

The present disclosure aims to solve at least one of the technical problems existing in the related art. As is well known, the formation of hot spots can cause thermal stress, which will lead to deformation of brake disc and change the contact status of brake system. As a result, the vibration signal features will change. Through establishing relationships between hot spots and vibration signals, a new method can be provided to solve the technical problems mentioned in Section [003]. Although this method (i.e., vibration analysis technology) has been widely used in other fields such as machinery fault diagnosis, but has not been used in the present field yet. To do this, the influences of hot spots formation, distribution, and size on the vibration signals have been clarified in our previous investigations, which play significant roles in this technology. Based on that, the present disclosure provides an early warning method, an early warning device, an early warning apparatus, and a storage medium for hot spots of a brake disc, which can perform early warning on the formation of the hot spots of the brake disc according to a mixed vibration signal of the brake disc, and the early warning effect is accurate and reliable.

In a first technical solution of the present disclosure, an early warning method for hot spots of a brake disc is provided. The early warning method includes:
acquiring a mixed vibration signal generated when the brake disc is braked;
separating the mixed vibration signal to obtain multiple separated vibration signals; and
screening the multiple separated vibration signals to obtain respective hot spot determination signals; where the hot spot determination signals are configured to determine formation of the hot spots on the brake disc.

According to the above embodiment, the present disclosure has the following effects. By separating the mixed vibration signal generated when the brake disc is braked, the multiple separated vibration signals can be obtained. Each of the multiple separated vibration signals is screened to obtain the respective hot spot determination signal that can reflect whether the hot spots are formed on the brake disc, and the hot spot early warning result is reliable. Since the multiple separated vibration signals are obtained based on a separation method of the mixed vibration signal, errors caused by unstable factors such as brake disc rotation and speed changes can be eliminated by the separation method, which can effectively improve the accuracy of hot spot early warning for the brake disc. Especially, when the present disclosure is applied to real-time monitoring, the hot spot early warning result is more accurate.

In an embodiment, the separating the mixed vibration signal to obtain multiple separated vibration signals includes: separating the mixed vibration signal based on a blind source separation algorithm to obtain the multiple separated vibration signals.

In an embodiment, before the screening the multiple separated vibration signals to obtain respective hot spot determination signals, the early warning method further includes:
acquiring a normal mixed signal generated before the brake disc is braked;
acquiring a braked mixed signal generated after the brake disc is braked;
separating the normal mixed signal to obtain multiple normal separated signals;
separating the braked mixed signal to obtain multiple braked separated signals;
comparing the multiple normal separated signals with the multiple braked separated signals to obtain adding separated signals;
acquiring a hot spot measurement signal generated when the brake disc is braked;
analysing the adding separated signals based on the hot spot measurement signal to obtain hot spot formation signals; and
obtaining a hot spot signal library based on the hot spot formation signals;
where the hot spot signal library is configured to screen the multiple separated vibration signals.

In an embodiment, the acquiring a hot spot measurement signal generated when the brake disc is braked includes: obtaining, by using an infrared thermal imager, the hot spot measurement signal after the brake disc is braked.

In an embodiment, the screening the multiple separated vibration signals to obtain respective hot spot determination signals includes: screening, based on the hot spot signal library, each of the multiple separated vibration signals to obtain the respective hot spot determination signal.

In an embodiment, after the screening each of the multiple separated vibration signals to obtain respective hot spot determination signals, the early warning method further includes: obtaining an alarm triggering signal based on the hot spot determination signals. The alarm triggering signal is configured to trigger an alarm.

In a second technical solution of the present disclosure, an early warning device for hot spots of a brake disc is provided. The early warning device includes: a data acquisition module, configured to acquire a mixed vibration signal generated when the brake disc is braked;
a signal separation module, configured to separate the mixed vibration signal to obtain multiple separated vibration signals; and
a signal screening module, configured to screen the multiple separated vibration signals to obtain respective hot spot determination signals; where the hot spot determination signals are configured to determine formation of the hot spots on the brake disc.

Since the early warning device is configured to perform the early warning method of the first technical solution, the early warning device has all technical effects of the early warning method.

In an embodiment, the data acquisition module is connected to multiple sensors, and the multiple sensors are configured to detect vibration of the brake disc.

In a third technical solution of the present disclosure, an early warning apparatus for hot spots of a brake disc is provided. The early warning apparatus includes: a memory, a processor, and a computer program stored in the memory and executed by the processor. The processor is configured to execute the computer program to implement the early warning method of the first technical solution.

Since the early warning apparatus is configured to perform the early warning method of the first technical solution, the early warning apparatus has all technical effects of the early warning method.

In a fourth technical solution of the present disclosure, a computer-readable storage medium is provided. The computer-readable storage medium stores computer-executable instructions, and the computer-executable instructions are configured to implement the early warning method of the first technical solution. The computer-readable storage medium may be a non-transitory computer-readable storage medium.

Since the computer-readable storage medium is configured to implement the early warning method of the first technical solution, the computer-readable storage medium has all technical effects of the early warning method.

The additional aspects and advantages of the present disclosure will be partially provided in the following description, and the additional aspects and advantages of the present disclosure will become apparent from the following description, or the additional aspects and advantages of the present disclosure will be understood through embodiments of the present disclosure.

### BRIEF DESCRIPTION OF DRAWINGS

The above additional aspects and advantages of the present disclosure will be apparent and easy to understand from the description of embodiments in conjunction with the following drawings.

FIG. 1 illustrates a schematic flowchart of an early warning method for hot spots of a brake disc in an embodiment of the present disclosure.

FIG. 2 illustrates a schematic diagram of a processing process of a blind source separation algorithm of the early warning method for the hot spots of a brake disc in the embodiment of the present disclosure.

FIG. 3 illustrates a schematic flowchart of step S010 to step S080 in the early warning method for the hot spots of a brake disc in the embodiment of the present disclosure.

FIG. 4 illustrates a structural schematic diagram of an early warning device for hot spots of a brake disc in an embodiment of the present disclosure.

### DESCRIPTION OF REFERENCE NUMERALS

410—data acquisition module; 411—sensor; 420—signal separation module; 430—signal screening module; 440—alarm module.

### DETAILED DESCRIPTION OF EMBODIMENTS

In the description of the present disclosure, unless otherwise explicitly defined, terms such as setting, installation, and connection should be interpreted in a broad sense, and those skilled in the art can reasonably determine the specific meaning of the above terms in the present disclosure in combination with specific contents of technical solutions. In the description of the present disclosure, the meaning of “several” is one or more; the meaning of “multiple” is more than two; “more than”, “less than”, and the like are understood to exclude this number; and “above”, “below”, “within” and the like are understood to include this number. Furthermore, features defined with “first” or “second” may explicitly or implicitly include one or more of the features. In the description of the present disclosure, unless otherwise specified, “a plurality of” means two or more.

In the related art, there are usually two methods used to determine whether there are hot spots on the surface of the brake disc. The first method is thermal infrared imaging temperature measurement, which is the most commonly used technical means. However, accuracy of the first method is deeply affected by emissivity of the brake disc, and other unstable factors such as temperature fluctuations and rotation of the brake disc combine with the emissivity of the brake disc result in significant errors in measurement data. The infrared imaging temperature measurement tends to be static measurement, and hot spot early warning based on the infrared imaging temperature measurement is not accurate. The second method is finite element theory calculation. By using finite element analysis software such as Ansys® and Abaqus® to simulate a braking process based on thermal mechanical coupling, thereby calculating a critical rate of hot spot formation. By comparing the critical rate with an actual speed of the vehicle, the formation of hot spots can be analyzed. When the second method is applied, the formation of hot spots can be avoided by controlling the vehicle speed reasonably. However, the reliability of this method heavily depends on the accuracy of model construction, boundary condition settings, etc., and there are inevitably idealized assumptions in theoretical calculations, leading to a deviation between the calculation result and an actual result. The finite element theory calculation mainly aims to static measurements, making it difficult to meet the needs of online detection.

Mechanical systems have their own inherent operating modes. When mechanical faults occur, vibration characteristics of the mechanical systems will fluctuate, such as vibration frequency, amplitude, etc. By analyzing these vibration signals, the location and type of faults can be determined. For a braking system, there are inherent operating modes corresponding to the speed and mechanical structure during a deceleration process. When hot spots are formed, they will cause changes in the vibration characteristics of the braking system, which can reflect whether hot spots are formed.

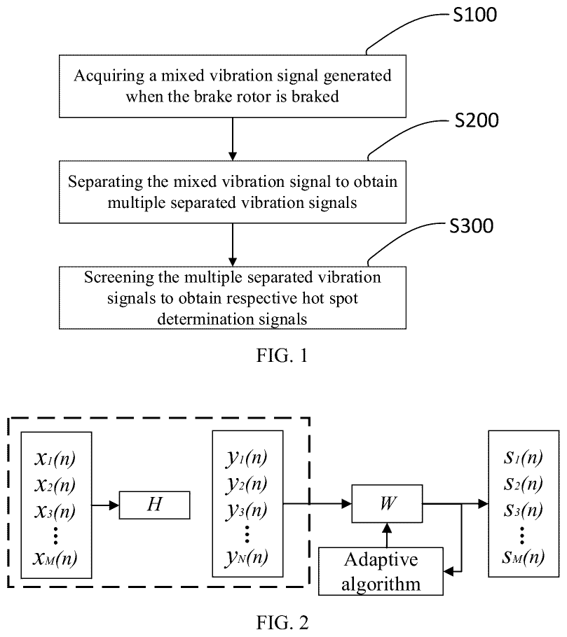

The following describes an early warning method, an early warning device, an early warning apparatus, and a storage medium for hot spots of a brake disc of the present disclosure with reference to FIGS. 1 to 4.

Referring to FIG. 1, a first technical solution of the present disclosure provides an early warning method for hot spots of a brake disc. The early warning method includes:
step S100: acquiring a mixed vibration signal generated when the brake disc is braked;
step S200: separating the mixed vibration signal to obtain multiple separated vibration signals; and
step S300: screening the multiple separated vibration signals to obtain respective hot spot determination signals; where the hot spot determination signals are configured to determine formation of the hot spots on the brake disc.

By separating the mixed vibration signal generated when the brake disc is braked, the multiple separated vibration signals can be obtained. The multiple separated vibration signals are screened to obtain the respective hot spot determination signals that reflect whether the hot spots are formed on the brake disc, and the hot spot early warning result is reliable. Since the multiple separated vibration signals are obtained based on a separation method of the mixed vibration signal, errors caused by unstable factors such as brake disc rotation and speed changes can be eliminated by the separation method, which can effectively improve the accuracy of early warning for hot spots for the brake disc. Especially, when the present disclosure is applied to real-time monitoring, the hot spot early warning result is more accurate.

Specifically, in the step S200, the mixed vibration signal is separated based on a blind source separation algorithm to obtain the multiple separated vibration signals.

Furthermore, in a process of separating the mixed vibration signal based on a blind source separation algorithm to obtain the multiple separated vibration signals, a mixed vibration signal Y is separated based on a separation matrix W, multiple separated vibration signals S are obtained, and S=W*Y. The separation matrix W is obtained by correction of an adaptive algorithm, and a specific processing process is shown in FIG. 2.

Specifically, Y=H*X and X(n)={xⱼ(n)} (j=1, 2, . . . , M; n=1, 2, . . . , T); X(n) represents unknown source signals of the brake disc; M represents the number of the unknown source signals; and T represents lengths of the unknown source signals. H=[hᵢⱼ]_{M*N}, H represents an unknown mixing matrix of the brake disc, and N represents the number of sensors. Furthermore, W=[Wᵢⱼ]_{M*N} and S(n)={Sⱼ(n)}(j=1, 2, . . . , M).

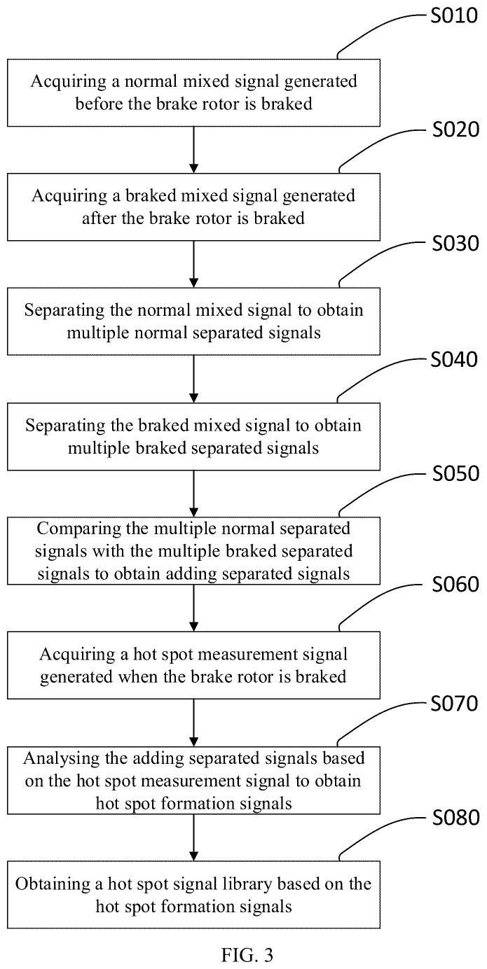

Referring to FIG. 3, before the step S300 (i.e., before the screening the multiple separated vibration signals to obtain respective hot spot determination signals), the early warning method further includes:
step S010: acquiring a normal mixed signal generated before the brake disc is braked; where the normal mixed signal is obtained by mixing unknown source signals generated before the brake disc is braked;
step S020: acquiring a braked mixed signal generated after the brake disc is braked; where the braked mixed signal is obtained by mixing unknown source signals generated after the brake disc is braked;
step S030: separating the normal mixed signal to obtain multiple normal separated signals; where the normal mixed signal is obtained by mixing the multiple normal separated signals;
step S040: separating the braked mixed signal to obtain multiple braked separated signals; where the braked mixed signal is obtained by mixing the multiple braked separated signals;
step S050: comparing the multiple normal separated signals with the multiple braked separated signals to obtain adding separated signals; where the adding separated signals are used to indicate differences between the multiple normal separated signals and the multiple braked separated signals, and the adding separated signals are specifically used to represent newly added vibration signals before and after the brake disc is braked;
step S060: acquiring a hot spot measurement signal generated when the brake disc is braked;
step S070: analysing the adding separated signals based on the hot spot measurement signal to obtain hot spot formation signals; and
step S080: obtaining a hot spot signal library based on the hot spot formation signals; where the hot spot signal library consists of the hot spot formation signals, and the hot spot signal library is configured to screen the multiple separated vibration signals.

Specifically, in a process of acquiring a hot spot measurement signal generated when the brake disc is braked, an infrared thermal imager is configured to obtain the hot spot measurement signal after the brake disc is braked.

Specifically, the hot spot measurement signal can be obtained not only by an infrared thermal imager, but also by a contact thermocouple.

In an embodiment, in a process of analyzing the adding separated signals based on the hot spot measurement signal to obtain hot spot formation signals, when the hot spot measurement signal indicates the formation of hot spots on the brake disc, then corresponding adding separated signals are determined to be the hot spot formation signals. When the hot spot measurement signal does not indicate the formation of the hot spots on the brake disc, corresponding adding separated signals are determined to be signals.

The hot spot formation signals are obtained by the above method to define the hot spot signal library, and the hot spot signal library is configured to screen and process the multiple separated vibration signals.

In an embodiment, in a process of screening the multiple separated vibration signals to respective obtain hot spot determination signals, each of the multiple separated vibration signals is screened based on the hot spot signal library to obtain the respective hot spot determination signal.

Specifically, according to the hot spot signal library, the multiple separated vibration signals are compared with the hot spot formation signals one by one. When the separated vibration signal corresponds to the hot spot formation signal, a hot spot is determined to be formed, and a hot spot determination signal is obtained and carries information of the formation of the hot spot. The hot spot determination signal is used to indicate the formation of the hot spot. Otherwise, the hot spot determination signal carries information of a normal operation, and the hot spot determination signal is used to indicate that no hot spot has been formed.

In an embodiment, after the step S300, the early warning method further includes a step: an alarm triggering signal is obtained based on the hot spot determination signals. The alarm triggering signal is configured to trigger an alarm.

Specifically, when the hot spot determination signal carries information of the formation of the hot spot, an alarm triggering signal is generated, and the alarm triggering signal is configured to trigger an alarm system for an alarm. When the present disclosure is applied to a braking process of the brake disc, the alarm can prompt a user to adjust the braking of the brake disc, thereby improving braking performance and the service life of the brake disc.

A braking simulation test is performed on a friction pair composed of a brake pad made of copper-based powder and a brake disc made of cast steel on a GDS® brake bench. By using the early warning method of the present disclosure, abnormal signals are detected during a braking process of the brake disc at a speed of 1980 revolutions per minute (rpm). Contact thermocouples are used for auxiliary verification to confirm the formation of the hot spot. Compared with a theoretical result of a finite element calculation (i.e., a speed of the brake disc is 2150 rpm) and an infrared thermal imaging monitoring result (i.e., a speed of the brake disc is 2090 rpm), the early warning method of the present disclosure is safer and more reliable.

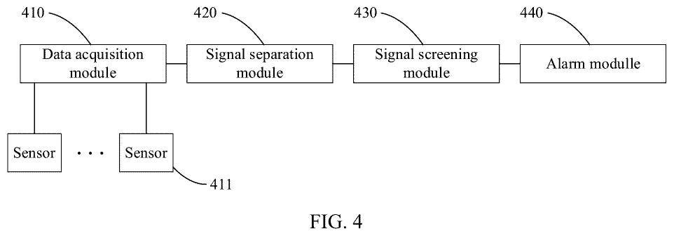

In a second technical solution of the present disclosure, referring to FIG. 4, an early warning device for hot spots of a brake disc is provided. The early warning device includes:
a data acquisition module 410, configured to acquire a mixed vibration signal generated when the brake disc is braked; where the data acquisition module 410 can be a data acquisition card;
a signal separation module 420, configured to separate the mixed vibration signal to obtain multiple separated vibration signals; and
a signal screening module 430, configured to screen the multiple separated vibration signals to obtain respective hot spot determination signals; where the hot spot determination signals are configured to determine formation of the hot spots on the brake disc.

The signal separation module 420 is embodied by software stored in at least one memory and executable by at least one processor, likewise, the signal screening module 430 is embodied by software stored in at least one memory and executable by at least one processor. In an embodiment, the data acquisition module 410 is connected to multiple sensors 411. The sensors 411 are used to detect the vibration data of the brake disc. The data acquisition module 410 can acquire mixed vibration signals when the brake disc is braked by the sensors 411. The sensors 411 can be acceleration sensors, displacement sensors, piezoelectric sensors, etc.

In an embodiment, the early warning device of the present disclosure further includes an alarm module 440. The alarm module 440 is configured to obtain an alarm trigger signal based on hot spots determination signals. The alarm trigger signal is used to trigger an alarm.

It should be understood that the device mentioned above can be implemented as software, firmware, hardware, and their appropriate combinations. Some or all physical components can be implemented as software executed by processors, such as central processing units, digital signal processors, or microprocessors. In addition, Some or all physical components can be implemented as hardware, or as integrated circuits (for example, dedicated integrated circuits).

In a third technical solution of the present disclosure, an early warning apparatus for hot spots of a brake disc is provided. The early warning apparatus includes a memory, a processor, and a computer program stored in the memory and executed by the processor. The processor is configured to execute the computer program to implement the early warning method provided in the first technical solution. Furthermore, the processor is connected to the memory through a bus or other means.

The memory, as a non-transient computer-readable storage medium, can be used to store non-transient software programs and non-transient computer executable programs. In addition, the memory may be a high-speed random access memory or a non-transient memory, such as at least one disk storage device, flash memory device, or other non-transient solid-state storage devices. In some embodiments, the memory may be a memory set remotely relative to the processor, the memory can be connected to the processor through networks. Types of the networks are not limited to the Internet, enterprise intranet, local area network, mobile communication network and their combinations.

The non-transient software program and instructions required to implement the early warning method of the first technical solution are stored in the memory. When the non-transient software program is executed by the processor, the early warning method for hot spots of the brake disc in the above embodiments is executed. In an embodiment, steps S100 to S300 and steps S010 to S080 of the early warning method are performed.

The embodiments of the apparatus described above are only illustrative, and units of the apparatus described as separate components may or may not be physically separated, that is, they can be located in one place or distributed across multiple network units. Some or all parts can be selected according to actual needs to achieve the purpose of the embodiments.

In addition, the fourth technical solution of the present disclosure provides a non-transitory computer-readable storage medium, and the non-transitory computer-readable storage medium stores computer-executable instructions. The computer-executable instructions are executed by a processor or a controller, for example, by a processor of the apparatus. The processor can execute the early warning method, for example, steps S100 to S300 and steps S010 to S080 of the early warning method are performed.

Those skilled in the art can understand that all or some steps and systems in the early warning method mentioned above can be implemented as software, firmware, hardware, and their appropriate combinations. Some or all physical components can be implemented as software executed by processors, such as central processing units, digital signal processors, or microprocessors, or as hardware, or as integrated circuits, such as dedicated integrated circuits. Such software can be distributed on computer-readable media, which may include computer storage media (or non-transient media) and communication media (or transient media). As commonly known to those skilled in the art, the term “computer storage medium” includes volatile and non-volatile, removable, and non-removable media implemented in any method or technique for storing information (such as computer-readable instructions, data structures, program modules, or other data). Computer storage media include but are not limited to random-access memory (RAM), read-only memory (ROM), electrically erasable programmable read-only memory (EEPROM), flash memory or other storage technologies, compact disc read-only memory (CD-ROM), digital multifunctional disc (DVD) or other optical disc storage, magnetic boxes, magnetic tapes, disk storage or other magnetic storage devices, or any other media that can be used to store desired information and can be accessed by computers. In addition, it is well known to those skilled in the art that communication media typically include computer-readable instructions, data structures, program modules, or other data in modulated data signals such as carriers or other transmission mechanisms, and may include any information delivery medium.

In the description of this specification, reference terms “an embodiment”, “some embodiments”, “illustrative embodiments”, “examples”, “specific examples”, or “some examples” refer to specific characteristics, structures, materials, or features described in conjunction with the embodiments or examples included in at least one embodiment or example of the present disclosure. In the specification, illustrative expressions of the above terms may not necessarily refer to the same embodiments or examples. Moreover, the specific characteristics, structures, materials, or features described can be combined in an appropriate manner in any one or more embodiments or examples.

Although embodiments of the present disclosure have been described, those skilled in the art may understand that various changes, modifications, substitutions, and variations can be made to these embodiments without departing from the principles and objectives of the present disclosure, and the scope of the present disclosure is limited by the claims and their equivalents.

What is claimed is:

1. An early warning method for hot spots of a brake disc, comprising:
acquiring a mixed vibration signal generated when the brake disc is braked;
separating the mixed vibration signal to obtain a plurality of separated vibration signals; and
screening the plurality of separated vibration signals to obtain respective hot spot determination signals; wherein the hot spot determination signals are configured to determine formation of the hot spots on the brake disc.

2. The early warning method for the hot spots of the brake disc as claimed in claim 1, wherein the separating the mixed vibration signal to obtain a plurality of separated vibration signals comprises: separating the mixed vibration signal based on a blind source separation algorithm to obtain the plurality of separated vibration signals.

3. The early warning method for the hot spots of the brake disc as claimed in claim 1, wherein before the screening the plurality of separated vibration signals to obtain respective hot spot determination signals, the early warning method further comprises:
acquiring a normal mixed signal generated before the brake disc is braked;
acquiring a braked mixed signal generated after the brake disc is braked;
separating the normal mixed signal to obtain a plurality of normal separated signals;
separating the braked mixed signal to obtain a plurality of braked separated signals;
comparing the plurality of normal separated signals with the plurality of braked separated signals to obtain adding separated signals;
acquiring a hot spot measurement signal generated when the brake disc is braked;
analysing the adding separated signals based on the hot spot measurement signal to obtain hot spot formation signals; and
obtaining a hot spot signal library based on the hot spot formation signals;
wherein the hot spot signal library is configured to screen the plurality of separated vibration signals.

4. The early warning method for the hot spots of the brake disc as claimed in claim 3, wherein the acquiring a hot spot measurement signal generated when the brake disc is braked comprises: obtaining, by using an infrared thermal imager, the hot spot measurement signal after the brake disc is braked.

5. The early warning method for the hot spots of the brake disc as claimed in claim 3, wherein the screening the plurality of separated vibration signals to obtain respective hot spot determination signals comprises: screening, based on the hot spot signal library, each of the plurality of separated vibration signals to obtain the respective hot spot determination signal.

6. The early warning method for the hot spots of the brake disc as claimed in claim 1, wherein after the screening the plurality of separated vibration signals to obtain respective hot spot determination signals, the early warning method further comprises: obtaining an alarm triggering signal based on the hot spot determination signals; and the alarm triggering signal is configured to trigger an alarm.

7. An early warning device for hot spots of a brake disc, comprising:
a data acquisition module, configured to acquire a mixed vibration signal generated when the brake disc is braked;
a signal separation module, configured to separate the mixed vibration signal to obtain a plurality of separated vibration signals; and
a signal screening module, configured to screen the plurality of separated vibration signals to obtain respective hot spot determination signals; wherein the hot spot determination signals are configured to determine formation of the hot spots on the brake disc.

8. The early warning device for the hot spots of the brake disc as claimed in claim 7, wherein the data acquisition module is connected to a plurality of sensors, and the plurality of sensors are configured to detect vibration of the brake disc.

9. An early warning apparatus for hot spots of a brake disc, comprising: a memory, a processor, and a computer program stored in the memory and executed by the processor; wherein the processor is configured to execute the computer program to implement the early warning method as claimed in claim 1.

10. A non-transitory computer-readable storage medium, wherein the non-transitory computer-readable storage medium stores computer-executable instructions, and the computer-executable instructions are configured to implement the early warning method as claimed in claim in claim 1.
